(19) United States
(12) Patent Application Publication
(10) Pub. No.: US 2008/0103775 A1
(43) Pub. Date: May 1, 2008

(54) Voice Recognition Method Comprising A Temporal Marker Insertion Step And Corresponding System

(75) Inventors: Denis Jouvet, Lannion (FR); Geraldine Damnati, Perros-Guirrec (FR); Lionel Delphin-Poulat, Trebeurden (FR)

Correspondence Address: MCKENNA LONG & ALDRIDGE LLP, 1900 K STREET, NW, WASHINGTON, DC, 20006, US

(73) Assignee: FRANCE TELECOM, Paris France (FR)

(21) Appl. No.: 11/665,678

(22) PCT Filed: Oct. 13, 2005
(86) PCT No.: PCT/FR05/02539

§ 371 Date: Oct. 11, 2007

(30) Foreign Application Priority Data
Oct. 19, 2004 (FR) 04-11096

(51) Int. Cl. G10L 15/18

(52) U.S. Cl. 704/257; 704/E15.018

(57) ABSTRACT

This voice recognition method comprises a decoding stage during which an enunciated word is identified on the basis of voice signal models described with the aid of voice units, each voice signal model representing a word belonging to a predefined vocabulary, and also comprises organizing voice signal models into an optimized lexical network associated with syntactic rules during which each word is identified with a word marker, wherein temporal information is inserted within the optimized lexical network in the form of additional generic markers, so as to spot relevant moments during the decoding.

The invention relates to speech recognition in audio signals, for example a signal uttered by a speaker.

The invention relates to a voice recognition method and automatic system based on the use of voice signal acoustic models, according to which speech is modeled in the form of one or more successions of voice unit models each corresponding to one or more phonemes.

More specifically, the invention relates to speech recognition, and more precisely to the preparation of recognition models for increasing the efficiency and elaboration of the task of decoding, i.e. the phase of comparing the signal to be recognized with the recognition model or models for identifying the word pronounced.

An especially useful application of such a method and such a system relates to automatic speech recognition for voice dictation or voice command within the context of interactive voice services associated with telephony.

Various kinds of voice signal modeling can be used in the context of speech recognition. In this respect, reference may be made to Lawrence R. Rabiner's article entitled “A tutorial on Hidden Markov Models and Selected Applications on Speech Recognition”, proceedings of the I.E.E.E., vol. 77, no. 2, February 1989. This article describes the use of hidden Markov models for modeling voice signals.

According to such modeling, a voice unit, for example a phoneme or a word, is represented in the form of one or more state sequences and a set of probability densities modeling the spectral forms that result from an acoustic analysis. The probability densities are associated with the states or the transitions between states. This modeling is then used for recognizing an uttered speech segment by the voice recognition system matching it with available models associated with known units (e.g. phonemes). The set of available models is obtained by prior training, with the aid of a predetermined algorithm.

In other words, thanks to a training algorithm, the set of parameters characterizing the voice unit models is determined based on identified samples.

Furthermore, in order to achieve good recognition performances, the phoneme modeling generally takes contextual influences into account, for example the phonemes preceding and following the current model.

The model compiling phase consists in producing and optimizing the recognition model constructed from syntactic knowledge comprising the rules of word chaining, lexical knowledge comprising the description of words in terms of smaller units such as phonemes, and acoustic knowledge comprising the acoustic models of the units chosen.

Word chains give rise to a syntactic network. Each word is then replaced by the lexical network corresponding to the description of the possible pronunciations of this word. Finally, each unit is replaced by its acoustic model.

Furthermore, at each processing step, the networks are optimized to eliminate redundancies, and thus reduce the overall size of the model. Optimization is used to reduce the requirements of the central processing unit for recognition proper, i.e. the decoding stage.

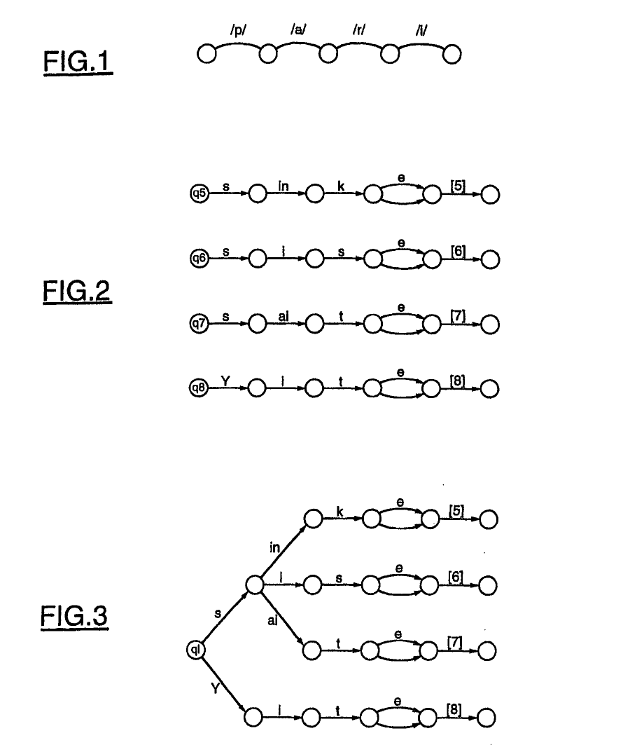

FIGS. 1 to 3 disclose an example of structuring of lexical models used. As can be seen in FIG. 1, each word of the vocabulary used for voice recognition is described in terms of voice units, here phonemes.

Thus, for the word “Paris” the French pronunciation in terms of phonemes can be written:

Paris [symbol] p . a . r . i

More complex descriptions are possible, based on subphonetic units, for example taking into account holding and explosion of plosive separations, or polyphones, i.e. the sequence of several phonemes. However, as they do not alter the principle of the invention, only phonetic units will be used in the disclosure of the invention, the transpositions to other units being obvious.

By way of example, a simple vocabulary will be considered, limited to the four digits “5” [“cinq”], “6” [“six”], “7” [“sept”] and “8” [“huit”], whose French phonetic descriptions are:

5 [symbol] s. in. k|s. in. k. e [symbol] s. in. k. (e ( ))

6 [symbol] s. i. s|s. i. s. e [symbol] s. i. s. (e|( ))

7 [symbol] s. ai. t|s. ai. t.e [symbol] s. ai. t. (e|( ))

8 [symbol] Y. i. t|Y. i. t. e [symbol] Y. i. t. (e|( ))

where “( )” designates the absence of any unit. For these digits, there are two possible pronunciations according to whether the e-muet “e” is pronounced or not. These lexical descriptions can be represented graphically in the form of the networks shown in FIG. 2. The references “[5]”, “[6]”, “[7]” and “[8]” designate markers corresponding to the words pronounced. These word markers correspond to the words pronounced and are placed at the end of the enunciated digit.

It will be noted that the approach transposes naturally into the case of transducers by using the phonemes as input symbols and the markers as output symbols. The reverse also applies according to the use made of the transducer.

The representation of FIG. 2 can be transformed by taking into account the fact that several words begin with the same phonemes, in this instance the digits “5”, “6” and “7”. The lexicons are then represented in the form of a lexical tree, as in FIG. 3. In this figure, the symbol “qI” represents the formal start of the tree. Then, given that the phoneme “s” is used at the beginning of the three digits “5”, “6” and “7”, a common transition is used for this phoneme. This operation enables the same models to be used when phonemes are common to several vocabulary words; the conversion into a tree enables the same models to be used for the phoneme sequences common to several word beginnings.

For voice recognition applications, the recognition system must recognize either isolated words, or word sequences. The lexical models shown for example in FIGS. 2 and 3 must be associated with a syntax. The role of syntactic models is to define the possible sequence of words for the application in question. Several approaches are possible. Either formal grammars explicitly defining the possible word sequences, or statistical grammars based on N-grams offering the succession probabilities of sequences of N words can be used. In the case of regular grammars, non-recursive grammars, and N-grams, it is possible to represent all the corresponding constraints in the form of a graph, for example a Markov chain or a probabilized transducer.

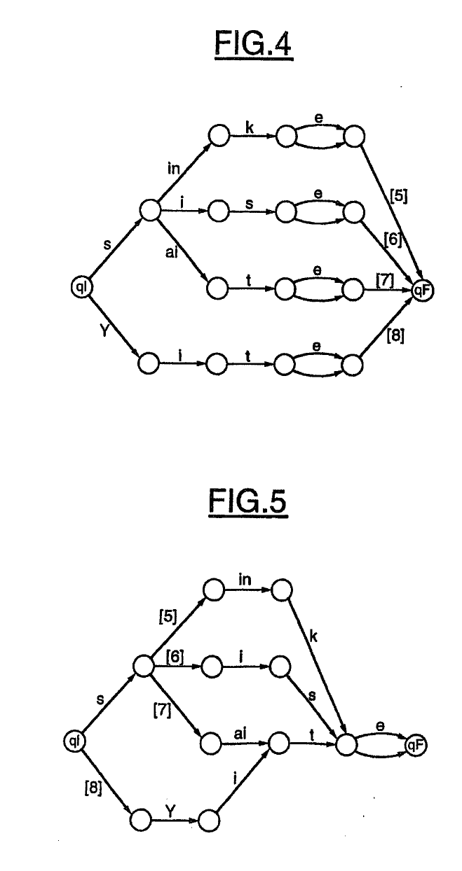

Once the various models (acoustic, lexical and syntactic) are defined, they can then be compiled to obtain the voice recognition model proper. When the vocabulary of an application is frozen, it is more efficient to precompile the corresponding model, either at the phonetic level, or at the acoustic level, according to the decoder employed. Precompilation can be used to optimize the corresponding network by eliminating, that is to say by factoring, any possible redundancies. Thus useless duplication of calculations during the decoding phase is avoided. Of course, it is possible to precompile a model corresponding to complete sentences or only portions of sentences, such as phrases. The first stage of compilation in the case of the vocabulary of the aforementioned four digits leads to the network shown in FIG. 4. In this figure, a single final terminal “qF” is used for the four vocabulary digits, the “s” common to the three first digits having already been factored during the preparation of the lexical models.

The network in FIG. 4 can be optimized, by taking into account that several words end in identical phoneme sequences. In this example, the repeated phoneme is the e-muet. This other optimization phase leads to the network example shown in FIG. 5. In this figure, the e-muet is common to all the vocabulary digits. Finally, all the word markers are found in the middle of the paths assigned to each digit of the vocabulary. That is, the word marker is placed at a spot in the path where the digit that has been pronounced by the speaker can be identified.

All optimizations, such as factoring phonemes and moving markers, are performed automatically by a compiler. Compiling models, which includes the network optimization phases with moving markers, proves very effective for continuous speech recognition. The graph then obtained is compact and the factoring of common phonemes at the beginning or end of words prevents the duplication of common calculations.

On the other hand, the movements of word markers needed for these optimizations caused information on the position of the end of words to be lost. This is especially disadvantageous when it is necessary to retrieve accurate temporal information, for example the instants of beginning and end of words.

Temporal information, for example the instants of beginning and end of recognized words, are essential e.g. for calculating accurate confidence measurements on the recognized words, as well as for the production of word graphs and word lattices and certain associated post-processing. Some multimodal applications also require an accurate knowledge of the instants of pronunciation of words. Lacking such information, it is impossible to connect and combine various modalities together, for example speech and pointing with a stylus or a touch screen. The loss of this information during the factoring phase is therefore very disadvantageous.

The use of graphs, as previously described, then poses the following problem: either an optimized network is used to the detriment of temporal information, or temporal information is needed and overall optimization of the network is relinquished.

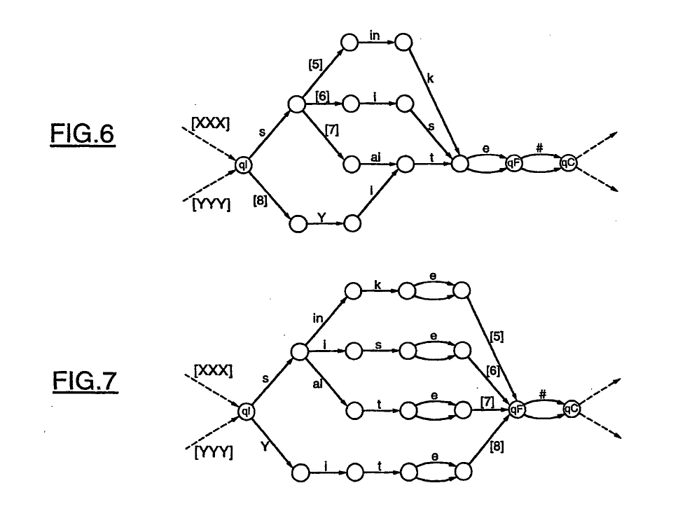

The extracts from networks shown respectively in FIGS. 6 and 7 illustrate these two alternatives. The network in FIG. 6 shows an optimized tree in which the word markers have been moved involving greater efficiency in the decoding, but not allowing the retrieval of accurate temporal information on the boundaries of the recognized words.

The reference “#” represents a pause which may be made after the enunciation of a word. The references [XXX] and [YYY] designate other lexical networks associated with the main network according to the defined syntactic rules.

The network shown in FIG. 7 preserves the place of the word marker. It therefore enables the word markers at the end of each recognized word to be preserved, and thus the boundaries between each word to be known. However, it is much bulkier and increases the requirements of the recognition unit.

The object of the invention is to remedy the drawbacks described above and thus to provide a method and a system of speech recognition, combining the advantages attached to optimizing lexical networks and obtaining temporal information concerning the enunciated word.

The invention provides a voice recognition method comprising a decoding stage during which an enunciated word is identified on the basis of voice signal models described with the aid of voice units, each voice signal model representing a word belonging to a predefined vocabulary. The method also comprises a step of organizing voice signal models into an optimized lexical network associated with syntactic rules during which each word is identified with a word marker. According to a general characteristic of the invention, temporal information is inserted within the optimized lexical network in the form of additional generic markers, so as to spot relevant moments during the decoding step.

This method also has the advantage of combining both an optimized lexical network and the presence of temporal information, thanks to the combined use of word markers and generic markers.

According to another characteristic of this method, the optimized lexical network comprises at least one lexical subnetwork in the form of an optimized lexical tree, each subnetwork describing a part of the predefined vocabulary words, each branch of the tree corresponding to voice signal models representing words.

In other words, each lexical tree is similar to a lexical subnetwork. A lexical tree corresponds to all the words of the vocabulary that can be used at a particular place in the utterance.

According to one characteristic of the invention, the optimized lexical network comprises a series of optimized lexical trees associated together according to an authorized syntax. The generic markers are then located between each lexical tree, in such a way as to identify the boundary between two words belonging to two successive lexical trees.

According to another embodiment, the voice signal models are organized on several levels with a first level including the optimized lexical network in the form of an optimized lexical tree looped back with the aid of an unconstrained loop, and a second level including all the syntactic rules. The generic marker is located at the end of the optimized lexical tree for retrieving word end temporal information.

The generic markers advantageously include an indication of word end or beginning.

They may also advantageously include an indication of the type of information concerned between two generic markers.

The subject of the invention is also a voice recognition system comprising a decoder suitable for identifying an enunciated word on the basis of voice signal models described with the aid of voice units, each voice signal model representing a word belonging to a predefined vocabulary. The system also comprises means of organizing voice signal models into an optimized lexical network associated with syntactic rules, and in which each word is identified with a word marker.

This voice recognition system further comprises means of inserting temporal information within the optimized lexical network in the form of additional generic markers, so as to spot relevant moments for the decoder.

The system disclosed above can be advantageously used for automatic speech recognition in interactive services associated with telephony.

Other objects, characteristics and advantages of the invention will appear on reading the following description, given solely by way of non-restrictive examples and referring to the attached drawings, in which:

FIG. 1, which has been referred to above, is a schematic representation of the breakdown of a word into phonemes;

FIGS. 2 to 7, which have also been previously mentioned, are schematic representations of the organization of lexical signal models into a network;

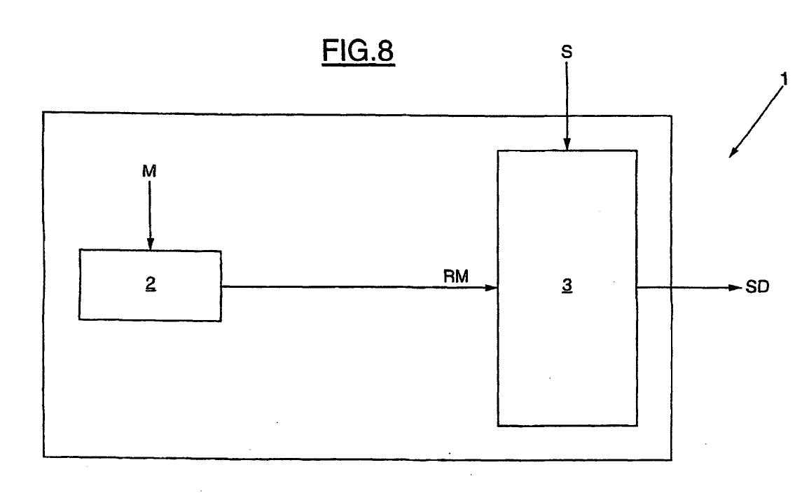

FIG. 8 is a block diagram illustrating the general structure of a voice recognition system according to the invention;

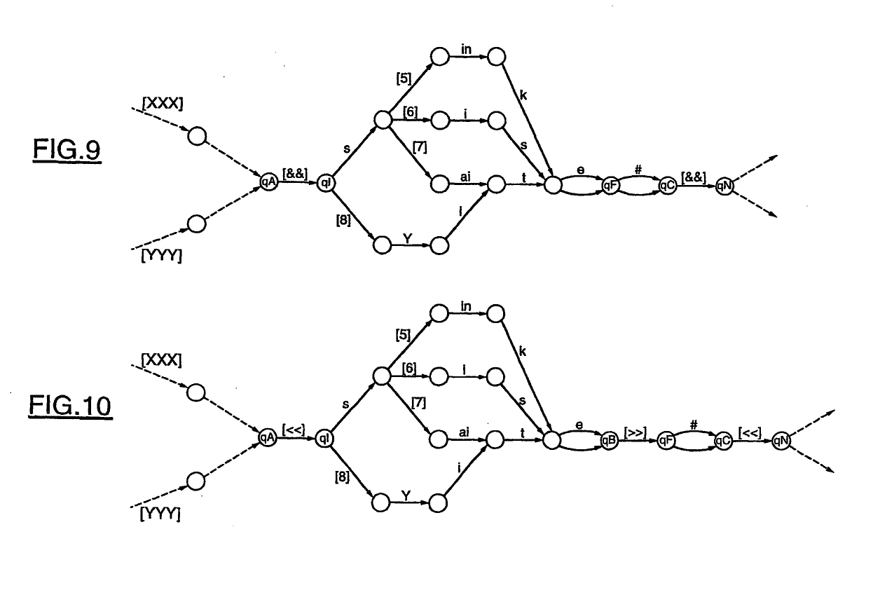

FIG. 9 is a schematic representation of a lexical network extract implemented in the method according to the invention;

FIG. 10 is a synoptic diagram illustrating a variant of the lexical network implemented in the voice recognition method according to the invention; and

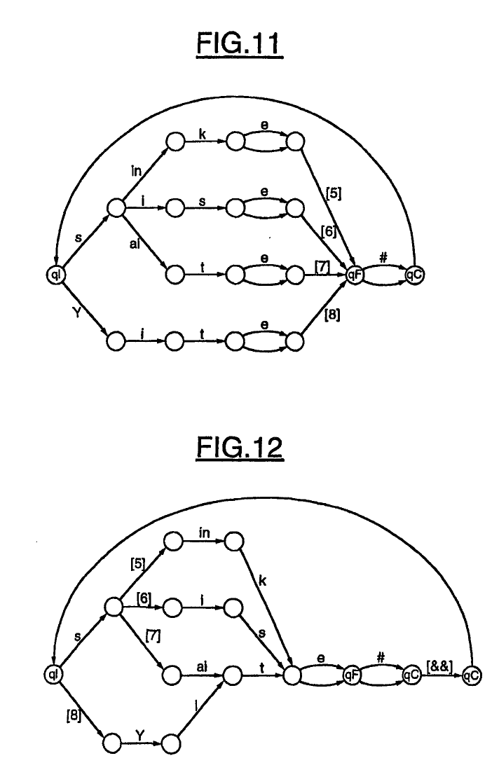

FIGS. 11 and 12 are synoptic diagrams illustrating another variant of a lexical network used in the voice recognition method according to the invention.

FIG. 8 is a very schematic representation of the general structure of a voice recognition system, in conformity with the invention, designated by the general numeric reference 1.

As can be seen, this system comprises means 2 suitable first for organizing the voice signal models M that it receives as input, into optimized lexical networks. Secondly, the means 2 insert temporal information within the voice signal models. This information will be described in more detail later.

The means 2 output optimized lexical networks RM into which temporal information has been inserted.

The system 1 also includes a decoder 3, which receives the voice signal S to be decoded and the optimized lexical network RM as input, so as to perform the voice signal recognition proper.

Reference is now made to FIG. 9, showing a lexical network extract originating from a step of organizing voice signal models according to the invention. Just as for FIGS. 6 to 7, the lexical network in FIG. 9 is integrated into a wider network comprising a succession of optimized lexical networks.

The lexical network in FIG. 9 has been optimized. It further comprises temporal information thanks to the addition of generic markers distinct from the word markers according to the method of the invention. They are represented in the figure by the sign [&&]. The purpose of these generic markers is to indicate the boundaries of words or relevant phrases to be identified, in this example the beginning and end of the word.

The addition of generic markers for defining the boundaries of relevant zones can be used to clearly separate the role and the functionality of the various markers: word markers are used to identify the recognized words, and temporal markers, here the generic markers, are used to spot relevant moments during decoding.

In this approach, word markers can be moved without constraint, which enables the networks to be effectively optimized as previously disclosed. On the other hand, the generic markers are not moved during the optimization phase.

It is also possible to differentiate the beginning and end markers of the relevant zones to be identified. This variant is illustrated in FIG. 10, where the beginning of a relevant zone is identified by the marker “[<<]” and the end by “[>>]”. This differentiation is useful when it is wanted to identify the position of just a few key words or phrases.

Temporal markers, i.e. generic markers, can be usefully turned to good account for indicating the beginning and/or the end of concepts considered useful to an application, for example the occurrence of a telephone number, a town name, an address, etc.

It is also possible to specify the type of information concerned in the temporal markers for facilitating subsequent application processing. For example, in the case of telephone numbers, “[NUMTEL<<]” markers can be used instead of “[<<]”, and where appropriate, “[NUMTEL>>]” instead of “[>>]”.

The marker sequence returned by the decoder will contain for example: “[NUMTEL<<]” [02] [96] [05] [11] [11] “[NUMTEL>>]”. This approach can be used to ensure that the sequence obtained between the markers results from the local syntax of the telephone numbers, and therefore to unambiguously identify the telephone number in the sequence of markers returned. The times associated with the “[NUMTEL<<]” and “[NUMTEL>>]” markers then provide temporal information on the beginning and end of the part of the utterance corresponding to the telephone number, information that is useful, for example, for calculating a confidence measurement on this zone, i.e. giving an indication regarding the reliability of the recognized words corresponding to this zone.

The approach also applies to the case of N-gram models represented in the form of a compiled network, whether N-grams of words or of classes of words or mixed.

The approach equally applies to the case of a mixture of N-grams and regular grammars.

Furthermore, several temporal markers can be interlinked with one another in order to more easily identify a concept and elements thereof at the same time.

Reference is made now to FIG. 11, which illustrates an organization into lexical networks different from that presented above. This other approach is termed “multilevel decoding”. Instead of compiling all the syntactic, lexical and acoustic knowledge in a single network, each of these is kept completely or partially separate.

For example, in the case of continuous speech recognition, one possible approach consists in using a compiled model corresponding to an unconstrained loop of all the vocabulary words, and in having a second knowledge source representing the syntactic level. The graph in FIG. 11 gives an indication of the structure of such a network acting as a support for the lexical model, in the classic example where the vocabulary is limited to the four digits “5”, “6”, “7” and “8”, before the replacement of the phonetic units by their corresponding acoustic model. In practice, the vocabularies usually handled are generally several thousands of words.

The decoder then makes use of both information sources at the same time: the compiled vocabulary network and the syntactic information. For this, it searches for the optimum path in a product graph, produced dynamically and partially during decoding. In fact, only the part of the network corresponding to the scanned zone is constructed.

As the upper level corresponds to the syntax, it happens each time that the decoder processes a transition comprising the word marker at the lower level, i.e. the compiled lexical model. This passage via the word markers entails taking the language model into account for deciding whether or not to extend the corresponding paths, either by blocking them completely if the syntax does not authorize them, or by penalizing them more or less according to the probability of the language model. In the graph in FIG. 11, it can clearly be seen that this information originating from the language model is only accessed, in this example, at the end of words, therefore after making the costly acoustic comparison on the whole word.

On the other hand, if the word markers are moved as illustrated in FIG. 12, the syntactic information is obtained much earlier, which enables the scanning of irrelevant paths to be halted more swiftly, taking into account the syntax in question.

However, as in the aforementioned examples, moving word markers no longer allows the end of word instants to be identified during decoding. On the other hand, by introducing generic markers as previously disclosed in the invention, the decoder is able to identify the temporal information specifying the end of word instants.

In another embodiment, it is possible to use other types of markers, chiefly for identifying the transitions associated with language models. In compiled models, there are actually transitions of a different kind: some are only used for acoustics, that is to say that they form part of the acoustic model corresponding to a phonetic unit; others are used to indicate the identity of words, these are word markers; others are used just as a support for generic markers for identifying temporal information; and yet others are used for carrying language model probabilities, i.e. they have a function equivalent to the transition probabilities of the syntactic network.

When this proves necessary, it is possible to use a special marker for identifying the transitions carrying a language model probability. This can be used to identify information, i.e. probabilities, associated during decoding and therefore to separate the contributions of the language model from those originating from acoustics in calculating decoding scores. This separation of contributions is necessary for example for calculating acoustic confidence measurements on recognized words.

1. A voice recognition method comprising a decoding stage during which an enunciated word is identified on the basis of voice signal models described with the aid of voice units, each voice signal model representing a word belonging to a predefined vocabulary, and also comprising organizing voice signal models into an optimized lexical network associated with syntactic rules during which each word is identified with a word marker, wherein temporal information is inserted within the optimized lexical network in the form of additional generic markers, so as to spot relevant moments during the decoding.

2. The method as claimed in claim 1, wherein the optimized lexical network comprises at least one lexical subnetwork in the form of an optimized lexical tree, each subnetwork describing a part of the predefined vocabulary words, each branch of the tree corresponding to voice signal models representing words.

3. The method as claimed in claim 1, wherein the optimized lexical network comprises a series of optimized lexical trees associated together according to an authorized syntax, and in that the generic marker is located between each lexical tree, in such a way as to identify the boundary between two words belonging to two successive lexical trees.

4. The method as claimed in claim 2, wherein the voice signal models are organized on several levels with a first level including the optimized lexical network in the form of an optimized lexical tree looped back with the aid of an unconstrained loop, and a second level including all the syntactic rules, and in that the generic marker is located at the end of the optimized lexical tree for enabling the activation of the syntactic level.

5. The method as claimed in claim 1, wherein the generic markers include an indication of word end or beginning.

6. The method as claimed in claim 1, wherein the markers include an indication of the type of information concerned between two generic markers.

7. A voice recognition system comprising a decoder suitable for identifying an enunciated word on the basis of voice signal models described with the aid of voice units, each voice signal model representing a word belonging to a predefined vocabulary, and also comprising means of organizing voice signal models into an optimized lexical network associated with syntactic rules, and in which each word is identified with a word marker, wherein the voice recognition system comprises means of inserting temporal information within the optimized lexical network in the form of additional generic markers, so as to spot relevant moments for the decoder.

8. The use of a system as claimed in claim 7 for automatic speech recognition in interactive services associated with telephony.
